(19) United States
(12) Patent Application Publication
(10) Pub. No.: US 2013/0054272 A1
(43) Pub. Date: Feb. 28, 2013

(54) SYSTEM AND METHOD FOR A HEALTHCARE MONITORING FRAMEWORK IN A NETWORK ENVIRONMENT

(71) Applicant: Net.Orange, Inc., Dallas, TX (US)

(72) Inventors: Vasu Rangadass, Arlington, TX (US); Ravi Seshadri, Plano, TX (US); Gregory J. Poe, Dallas, TX (US)

(73) Assignee: NET.ORANGE, INC., Dallas, TX (US)

(21) Appl. No.: 13/659,863

(22) Filed: Oct. 24, 2012

Related U.S. Application Data
(63) Continuation-in-part of application No. 12/536,060, filed on Aug. 5, 2009.
Application No. 12/536,060 is a continuation-in-part of application No. 12/816,804, filed on Jun. 16, 2010.
Application No. 12/816,804 is a continuation-in-part of application No. 12/536,060, filed on Aug. 5, 2009.
(60) Provisional application No. 61/086,344, filed on Aug. 5, 2008.

(51) Int. Cl. G06Q 50/24

(52) U.S. Cl. 705/3

(57) ABSTRACT

A method is provided in one example embodiment and includes receiving data from a source, where the data includes medical data and non-medical data associated with an individual, converting the data into a health record of the individual, extracting a plurality of vectors from the medical data in the health record, and generating a healthcare signature of the individual from the plurality of vectors. The medical data may be generated by one or more medical systems and may include information from one or more medical fields. The medical data from different sources can be in different formats. The method can further include monitoring the plurality of vectors over time and generating a longitudinal medical record of the individual. The method can further include facilitating displaying the health record, the healthcare signature and the longitudinal medical record of the individual on an interface.

### CROSS-REFERENCE TO RELATED APPLICATION

This Application is a continuation-in-part and claims the benefit of priority under 35 U.S.C. §120 to U.S. application Ser. No. 12/536,060, entitled “Operating System” filed Aug. 5, 2009, which application claims the benefit of priority to U.S. Provisional Application Ser. No. 61/086,344, entitled “Operating System” filed Aug. 5, 2008. This Application is also a continuation-in-part and claims the benefit of priority under 35 U.S. §120 to U.S. application Ser. No. 12/816,804, entitled “Operating System” filed Jun. 16, 2010, which application is a continuation-in-part of 12/536,060, entitled “Operating System” filed Aug. 5, 2009, which application in turn claims the benefit of priority to U.S. Provisional Patent Application Ser. No. 61/086,344, entitled “Operating System” filed Aug. 5, 2008. The disclosures of the prior applications are considered part of, and are incorporated by reference in their entireties in, the disclosure of this Application.

### TECHNICAL FIELD

This disclosure relates in general to the field of healthcare systems and, more particularly, to a system and a method for a healthcare monitoring framework in a network environment.

### BACKGROUND

Paper-based medical records have been in existence for centuries and are being gradually replaced by computer-based records in modern healthcare systems. Hospitals are increasingly using electronic medical records (EMRs), electronic health records (EHRs), electronic patient records (EPRs), computer-based patient records (CPRs), etc. to capture and manage patients' medical and health information electronically. As of 2002, there were five different types of personal health records: (i) off-line personal health record; (ii) web-based commercial personal health record; (iii) web-based functional personal health record; (iv) provider based personal health record; and (v) web-based partial personal health record. Except for the provider based personal health record, all the other types of personal health records were created by the patient or by third parties, not including the health provider. The types and formats of health records have increased exponentially since 2002, and there currently exists myriad, diverse electronic representations of health and medical records from a wide variety of medical systems and other sources.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a healthcare monitoring system for providing a healthcare monitoring framework in a network environment according to an example embodiment;

FIG. 2 is a simplified block diagram illustrating example details of an embodiment of the healthcare monitoring system;

FIG. 3 is a simplified block diagram illustrating other example details of an embodiment of the healthcare monitoring system;

FIG. 4 is a simplified block diagram illustrating yet other example details of an embodiment of the healthcare monitoring system;

FIG. 5 is a simplified block diagram illustrating yet other example details of an embodiment of the healthcare monitoring system;

FIG. 6 is a simplified diagram illustrating yet other example details of an embodiment of the healthcare monitoring system;

FIG. 7 is a simplified diagram illustrating yet other example details of an embodiment of the healthcare monitoring system; and

FIG. 8 is a simplified flow diagram illustrating example operations that may be associated with an embodiment of the healthcare monitoring system.

### DETAILED DESCRIPTION OF EXAMPLE EMBODIMENTS

### Overview

A method is provided in one example embodiment and includes receiving data from a source, where the data includes medical data and non-medical data associated with an individual, converting the data into a health record of the individual, extracting a plurality of vectors from the medical data in the health record, and generating a healthcare signature of the individual from the plurality of vectors. The medical data may be generated by one or more medical systems and may include information from one or more medical fields. The medical data from different sources can be in different formats. The method can further include monitoring the plurality of vectors over time and generating a longitudinal medical record of the individual. The method can further include facilitating displaying the health record, the healthcare signature and the longitudinal medical record of the individual on an interface.

In a specific embodiment, the healthcare signature can be used to assess a health condition of the individual within specific time duration. The longitudinal medical record can be used to assess a health history of the individual. In other embodiments, the interface may be configured to facilitate communicating, displaying, reviewing, and manipulating the health record, the healthcare signature, the longitudinal medical record, and other information, which may include non-medical data.

### Example Embodiments

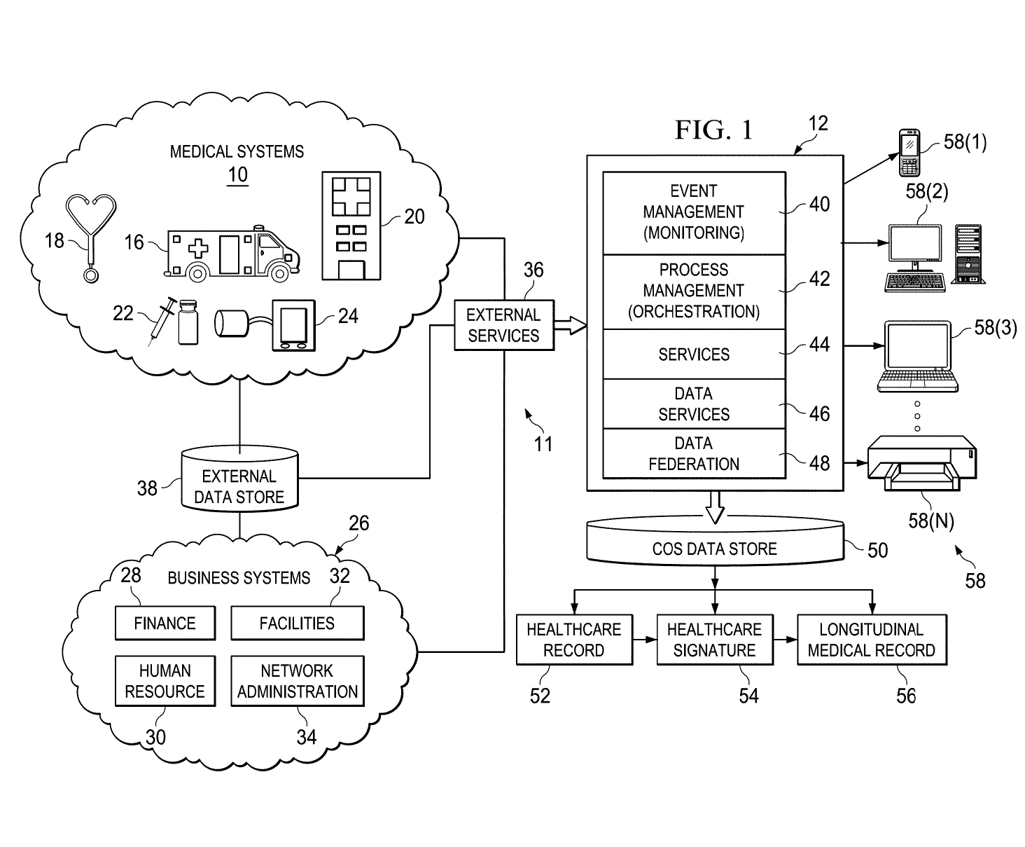

Turning to FIG. 1, FIG. 1 is a simplified block diagram illustrating a healthcare monitoring system 10 for a healthcare monitoring framework in a network environment. Healthcare monitoring system 10 includes a network 11 (generally indicated by an arrow) comprising a clinical operating system (cOS) 12 that can interface with medical systems 14, comprising a wide variety of medical data sources, such as ambulances 16, healthcare practitioners 18, hospitals 20, pharmacies 22, and medical devices 24. The examples of medical systems 14 provided herein are merely for ease of illustration, and are not intended to be limitations. Virtually any type and number of medical data sources may be encompassed within medical systems 14.

cOS 12 may also interface with business systems 26, including finance 28, human resources 20, facilities 32, and network administration 34. The examples of business systems provided herein are merely for ease of illustration. Virtually any type and number of sources that can provide non-medical data may be included within business systems 26. Medical systems 14 and business systems 26 may interface with cOS 12 through external services 36 (e.g., Internet, wireless communication networks, etc.) that may interface with cOS 12. Moreover, medical systems 14 and business systems 26 may store data in various formats in an external data store 38.

According to various embodiments, cOS 12 may include various modules that facilitate interfacing with medical systems 14 and business systems 26 through external services 36. Merely as illustrations, and not as limitations, examples of such modules include event management (monitoring) 40, process management (orchestration) 42, services 44, data services 46, and data federation 48. Data processed by cOS 12 may be stored in a cOS data store 50 in various formats, including as a health record 52, a healthcare signature 54, and a longitudinal medical record 56. cOS 12 may also facilitate transmitting the data to, and displaying the data on, various clients 58(1)-58(N) (collectively referred to as clients 58).

Certain terminologies are used with regard to the various embodiments of the present disclosure. As used herein, the term “medical data” includes information (e.g., facts) related to diagnosis and treatment of a current or potential health condition (e.g., disease, diabetes, obesity, aging, etc.). Medical data includes health information of an individual (e.g., information pertaining to the health of the individual or health care provided to the individual) collected from the individual at one or more of medical systems 14, including hospital, nursing home, medical center, clinic, health or nursing agency, health care facilities, or data provided by the individual or relatives and friends of the individual. Medical data may be generated by medical systems 14 during medical encounters (e.g., visit at physician's office), or otherwise (e.g., individual measuring own blood pressure at home, pharmacies dispensing medications, etc.). Medical data can include demographic information (e.g., age, weight, gender) that may be relevant to diagnosis and treatment of a current or potential health condition.

“Non-medical data” includes all data that is not medical data. Examples of non-medical data include health insurance information of the individual, amount spent by the individual on healthcare, outstanding payments due, past payments collected, the individual's occupational information, etc. “Data” as used herein in this specification, refers to any type of numeric, text, voice, video, or script data, or any type of source or object code, or any other suitable information in any appropriate format that may be communicated from one point to another in electronic devices and/or networks. Data includes medical data and non-medical data.

As used herein, the term “health record” can include an aggregation of medical and non-medical data in a uniform format that is accessible and render-able by plurality of clients 58(1)-58(N). As used herein, the term “format” can include an arrangement of data for storage, display, communication, printing, etc. Examples of formats include hypertext markup language (HTML), text, extensible markup language (XML), etc. The term “uniform format” is intended to encompass data arrangements that can be rendered on a common interface simultaneously. For example, an HTML format file can permit a web browser to render text and images simultaneously. Information that can be stored in health record 52 can include demographics, medical history, medication and allergies, immunization status, laboratory test results, radiology images, vital signs, personal statistics like age and weight, and billing information associated with an individual.

“Healthcare signature” as used herein, includes an aggregation of a plurality of vectors, where each “vector” represents a measurable piece of medical data, such as height, weight, heart rate, blood sugar level, etc. Healthcare signature 54 can represent a snapshot of an individual's state of health (e.g., health condition) in a certain period of time (e.g., a day, a month, a year, etc.) “Longitudinal medical record” can include a progression of the vectors over time. Longitudinal medical record 56 can include medical data that represents the individual's health condition as it changes (or remains constant) over time. In other words, longitudinal medical records 56 can present a health history of the individual, obtained by observing the same vectors over long periods of time.

In some embodiments, health record 52, healthcare signature 54, and longitudinal medical record 56 may include data associated with the individual from birth to death. In other embodiments, health record 52, healthcare signature 54, and longitudinal medical record 56 may include data associated with the individual over a shorter time period (e.g., a few decades, or a few years, etc.). In yet other embodiments, health record 52, healthcare signature 54, and longitudinal medical record 56 may include data associated with the individual since a start of a medical condition (e.g., diabetes, etc.)

According to various embodiments, healthcare monitoring system 10 may leverage existing legacy systems, such as existing EMRs, health information exchanges (HIE) and insurance claims systems, in real-time, to allow hospitals, physician practices, employers, payors and other entities in medical systems 14 and business systems 26 to work together and thrive in a value-driven accountable healthcare environment, regardless of the payment model. Applications in cOS 12 can provide predictive analytics and care coordination workflows for all stakeholders in the care continuum including medical systems 14 and business systems 26, such as physicians and their staff, hospital administrators, community care providers, disease and wellness management coaches, health plan administrators, patients and their caregivers.

For purposes of illustrating the techniques of healthcare monitoring system 10, it is important to understand the communications in a given system such as the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

The development of an Information Technology (IT) infrastructure has enormous potential to improve the safety, quality, and efficiency of health care and health delivery. Computer-assisted diagnosis can improve clinical decision making. Computer-based reminder systems can improve compliance with preventive service protocols. Immediate access to computer-based clinical information, such as laboratory and radiology results can improve quality of healthcare delivery. Likewise, the availability of complete patient health information at the point of care delivery, clinical decision support systems and other computer-assisted healthcare monitoring systems can prevent many errors and adverse events. Patient health information can be shared amongst all authorized participants in the health care community via secure IT infrastructure

Computer based systems typically use electronic health records (EHRs) to store patient information. Generally, an EHR system includes (1) longitudinal collection of electronic health information for and about individuals; (2) immediate electronic access to individual- and population-level information by authorized users; (3) provision of knowledge and decision-support that enhance the quality, safety, and efficiency of patient care; and (4) support of efficient processes for health care delivery. Some of the building blocks of an EHR system are the EHRs maintained by providers (e.g., hospitals, nursing homes, ambulatory settings, etc.) and by individuals (also called personal health records).

Generally, according to the Institute of Medicine (IOM), primary uses of the EHR system are: patient care delivery, patient care management, patient care support services, financial and other administrative processes, and patient self management. Secondary uses of the EHR system are: education, regulation, research, public health and homeland security, and policy support. The criteria proposed by IOM to assess EHR systems include: improving patient safety, supporting delivery of efficient patient care, facilitating management of chronic conditions, improving efficiency, and feasible implementation.

Core functionalities of the EHR system, according to IOM, typically includes health information and data collection and storage, results management, order entry/management, decision support, electronic communication and connectivity, patient support, administrative processes, and reporting and population health management. For example, information on patient allergies and other medications, along with alerts and reminders, can decrease the number of medication-related adverse events and improve prescribing practices of physicians and nurse practitioners.

Various vendors provide proprietary software to facilitate and/or implement EHR systems. Many of the proprietary software target portions of the overall EHR system, for example, offering clinical management software allowing small scale physician practices to store patient data electronically (without real-time updates from hospital systems), or offering administrative functionalities (e.g., order management, billing, etc.) for specialty practices (e.g., physiotherapy, rehabilitation, etc.), or offering pharmacy and prescription order entry without linking to patient health information, etc. Typically, existing EHR systems tend to be local stand-alone systems that allow storage, retrieval and manipulation of medical records within a proprietary network (e.g., local area networks, enterprise networks, etc.). Many of such existing EHR systems may not fit all healthcare environments, and may lack interoperability with each other.

Each healthcare environment may function differently, often in significant ways, leading to a difficulty in creating a “one-size-fits-all” EHR system. Many EHR companies employ vendors to provide customization so that a physician's input interface closely mimics previously utilized paper forms. However, customizations can lead to costly upgrades, and is effective only when utilized properly. Development and maintenance of customized interfaces can also lead to higher software implementation and maintenance costs.

Moreover, many of the proprietary software EHR systems can be incompatible with each other. Even within a single hospital system, different practices (e.g., surgery, orthopedics, pediatrics, etc.) can use different, incompatible software, preventing accessing and viewing a patient's record across practice areas and over time. EHR systems from diverse sources, such as pharmacies, private healthcare practitioners, nursing homes, etc., may be likewise incompatible with each other.

Another challenge facing health care professionals is diagnosing and treating a patient while simultaneously monitoring the overall health of the patient. Indeed, while the health care professional may treat the patient with a type of medicine that cures a set of health conditions related to a portion of the patient's body, the medicine may also cause problems in other portions of the patient's body. For example, a person with high blood pressure may be prescribed a medicine to lower the blood pressure, but the medicine may also cause blurred vision.

Many existing EHR systems provide a peep-hole view of the individual's health history, for example, presenting only a portion of the data to physicians. Reasons for such partial display of health history can range from lack of access to relevant data, to lack of computing resources and mechanisms to display the data efficiently. For example, the physician may be presented with dropdown menus and templates to enter information, which can discourage the physicians from reviewing the past patient history and medications. In other scenarios, lack of interoperability may result in compartmentalization of patient data, leading to the peep-hole view, even within the same enterprise.

Yet another challenge in some existing EHR systems is incompatibility between different forms used in various data entry operations. For example, a paper mail may be scanned and stored electronically. In some scenarios, an optical character recognition (OCR) system may translate the scanned mail into an electronic searchable form. In other scenarios, an employee may manually enter relevant information from the paper mail into a pre-defined template. In another example, an invoice may be prepared and sent in one form; the recipient may translate the invoice into another form compatible with the recipient's computer system. Although electronic data interchange (EDI) systems exist to convert certain forms in one format into another format, existing EDI systems are not cheap or efficient.

Moreover, the information from disparate systems may be presented to the user on multiple applications, interfaces, and other portals. For example, the user would access email using a particular application, then switch to another application to review patient records, then switch to yet another application or computer to view radiology results, etc. Such switching between applications, portals, interfaces, etc., may lead to erroneous clinical diagnosis, inefficiency, miscommunication, and other problems.

Healthcare monitoring system 10 is configured to address these issues (and others) in offering a system and a method for a healthcare monitoring framework in a network environment. Embodiments of healthcare monitoring system 10 can receive data from a source, including medical data associated with an individual (e.g., patient), convert the medical data into health record 52 of the individual, extract a plurality of vectors from health record 52, and generate healthcare signature 54 of the individual from the plurality of vectors. The plurality of vectors may be monitored over time to generate longitudinal medical record 56 of the individual.

In some embodiments, data related to health record 52 alone may be stored in cOS data store 50. Healthcare signature 54 and longitudinal medical record 56 may be generated in response to user queries. For example, a physician may click a tab on a suitable interface in client 58(1), which may generate a query for healthcare signature 54. Vectors may be extracted from health record 52, and transmitted to client 58(1), where the interface may render the vectors in a suitable format as healthcare signature 54. In other embodiments, health record 52, healthcare signature 54 and longitudinal medical record 56 may be generated as and when relevant data is made available at cOS 12. Thereafter, health record 52, healthcare signature 54 and longitudinal medical record 56 may be stored in cOS data store 50 and retrieved by suitable queries on clients 58.

In some embodiments, each individual may have a corresponding and unique health record 52, healthcare signature 54 and longitudinal medical record 56. Health record 52 may be generated from a plurality of medical data sources, irrespective of whether the medical data sources provide data in consistent or compatible formats. cOS 12 may enable in-house and remote access to the individual's medical data, including health record 52, healthcare signature 54, and longitudinal medical records 56. cOS 12 may enable real-time data reporting, and substantially complete information across a continuum of care.

For example, an individual may suffer a heart attack, and ambulance 16 may send in measurements of the individual's vital signs in a hospital's proprietary data format via a wireless transmitter. The individual may be brought to hospital 20, where doctors from several medical fields may examine him, measure various medical parameters related to his health and prescribe medications. Hospital 20 may store the information related to the individual over the course of several days or months, in the hospital's EMR database (e.g., external data store 38).

After being discharged from the hospital, the individual may purchase medications from pharmacy 22. Pharmacy 22 may provide data on medicines bought by the individual on a specific date. The medication data may be provided via proprietary systems of pharmacy 22, for example, in Microsoft Excel format. The individual may measure his blood pressure on medical device 24 (e.g., blood pressure monitor) and send the data to cOS 12 in a text message. The individual's primary care physician (healthcare practitioner 18) may enter the medication prescription and corresponding vectors and health conditions via an email message in text format.

cOS 12 may aggregate information from the various medical data sources, convert them to a uniform format (e.g., XML based format), and store the information in cOS data store 50 as health record 52 of the individual. The time of receipt (or measurement) of the data, the source of the data, and other relevant information associated with the data may also be saved into health record 52. Health record 52 may be accessed by clients 58(1)-58(N), and viewed thereon, irrespective of the particular operating system or applications on clients 58(1)-58(N). For example, turning back to the example of the individual who suffered the heart attack, a specialist may be consulted a few years after the hospitalization. The specialist may access and view health record 52 on client 58(1), irrespective of the particular operating system on client 58(1). For example, a web browser in client 58(1) may render health record 52 in a suitable format.

cOS 12 may extract vectors from the medical data (or health record 52) and compile them into healthcare signature 54. Depending on when the medical data (from which the vectors were extracted) were generated, the plurality of vectors can provide a snapshot of the individual's health condition during the time period of generation of the medical data. For example, the individual may turn 56 on Feb. 10, 2012, get a physical checkup on February 12 (when his height, weight, blood pressure, etc. are measured), and measure his blood glucose level everyday. His healthcare signature 54 in 2012 may present an aggregate of the information collected during the course of the year. Vectors measured more than once may be averaged (or the maximum, minimum, or other statistical measure computed, suitably, based on particular needs) over the specific time duration of interest (e.g., 2012).

The vectors may be monitored over time to generate longitudinal medical record 56 of the individual. For example, the individual's blood glucose level may be monitored over the course of a year, and presented as a timeline, showing the impact of medications, exercise, diet, and other daily activities and parameters on the specific vector. Longitudinal medical record 56 may be used to assess the health history of the individual. Longitudinal medical record 56 may also be used to discern the influence of various parameters from different medical fields on the individual's health condition. For example, vectors related to a kidney related treatment may show an unusual trend during a time period when the individual was undergoing a treatment for heart attack, indicating a possible interaction between the two treatments.

According to various embodiments, health record 52, healthcare signature 54 and longitudinal medical record 56 stored in cOS data store 50 may be searchable through a search query on a suitable interface. For example, health record 52, healthcare signature 54 and longitudinal medical record 56 may be searched to find similar health records, healthcare signatures or longitudinal medical records. In another example, a person with kidney issues might want to see how another person with a similar healthcare signature reacted to a certain type of medicine. In another example, an oncologist treating an individual with chemotherapy and radiation may monitor the size of the cancer and the rest of the individual's healthcare signature 54 to ensure that the individual's overall immune system is not getting weaker.

Further, health record 52, healthcare signature 54 and longitudinal medical record 56 of a subset of population could be monitored by government institutions like regional health centers, Center for Disease Control, Environmental Protection Agency, Federal Emergency Management Agency and/or the Department of Homeland Security for trends and/or epidemics. Additionally, clinical trials could also use data in cOS data store 50 to store and update health care record 52, healthcare signature 54 and longitudinal medical record 56.

cOS 12 may enable reviewing and completing patient histories, past visits, current medications, allergies, labs and diagnostic tests on a single interface. A user (e.g., medical practitioner, patient, etc.) can view the information on the interface without having to open several different applications. cOS 12 may enable management of patient flow across multiple healthcare enterprises (e.g., medical systems 14), immediate access to patient records (e.g., health record 52, healthcare signature 54, longitudinal medical record 56, etc.), electronic communication with referring physicians and secure consult notes and clinical data.

In various embodiments, cOS 12 may comprise a plurality of self-contained interconnected modules and service layers for connecting proprietary (and public) systems together and extracting and translating data therefrom to enable them to cooperate in a software ecosystem while allowing flexible connections with both existing and new applications. cOS 12 can enable building new applications without re-writing proprietary systems regardless of any changes to external systems and devices.

In various embodiments, cOS 12 may be based upon a service-oriented architecture approach with application abstraction. Systems connected with cOS 12 can “Plug and Play” without requiring any specialized drivers or installation and supply or use data in schema-compliant form through suitable adapters. cOS 12 may provide an interface between a consumer and a provider for messages representing clinical events. cOS 12 may translate messages to enable service layers and modules within cOS 12 to receive data and manipulate the received data for further operations. In various embodiments, cOS 12 may map data in accordance XML schemas as appropriate.

Event management (monitoring) 40 may comprise a routing services layer that provides services associated with processing of routing requests to medical systems 14 and business systems 26, including routing, logging, and monitoring of messages. Process management (orchestration) 42 may comprise a configuration services layer having an XML based registry that stores data for supporting configuration settings, for example, a registry holding information about medical systems 14 and business systems 26, pool data, message type, and such other schema information.

Services 44 may comprise an application services layer that supports and interfaces with various applications hosted at, or run by, medical systems 14 and business systems 26. Services 44 may include patient service providing an authoritative patient identifier (e.g., userid, patient social security number, etc.) and demographic information (e.g., age, gender, etc.) within cOS 12; practitioner service providing an authoritative identifier (e.g., userid, Federal Employer Identification number, etc.) of healthcare providers and corresponding provider information within cOS 12; consent service providing role-based privacy constraints on data within cOS 12, including Health Insurance Portability and Accountability Act (HIPAA) mandated constraints; clinical event service providing an authoritative index of clinical event information available within cOS 12; and administration services maintaining data stored within each service layer and cOS data store 50. Services 44 may further comprise an administration portal comprising an interface allowing administrators to maintain the services and data held in cOS 12.

Data services 46 may translate requests from services 44 into message routing requests to appropriate recipient applications. Operations by services 44 may be maintained and validated from both a content and security perspective by data services 46. Data services 46 may also provide a data access layer, exchanging data between consumers and providers in appropriate formats suitable to recipients, irrespective of formats of data from suppliers. Data federation 48 may aggregate data received from medical systems 14 and business systems 26 into cOS data store 50.

Clients 58(1)-58(N) may include any electronic device, client, server, peer, service, application, or other object capable of sending, receiving, or forwarding information over a network (e.g., network 11). Examples of clients 58(1)-58(N) include computers, laptops, smartphones, printers, etc. Clients 58(1)-58(N) may be provisioned with suitable interfaces (e.g., web browsers) that can render data, including browser code, provided by cOS 12 to facilitate displaying health records 52, healthcare signature 54, longitudinal medical records 56, and other information.

Turning to the infrastructure of healthcare monitoring system 10, the network topology of network 11 can include any number of servers, routers, gateways, and other nodes inter-connected to form a large and complex network. A node may be any electronic device, client, server, peer, service, application, or other object capable of sending, receiving, or forwarding information over communications channels in a network. Elements of FIG. 1 may be coupled to one another through one or more interfaces employing any suitable connection (wired or wireless), which provides a viable pathway for electronic communications. Additionally, any one or more of these elements may be combined or removed from the architecture based on particular configuration needs.

Healthcare monitoring system 10 may include a configuration capable of TCP/IP communications for the electronic transmission or reception of data packets in a network. Healthcare monitoring system 10 may also operate in conjunction with a User Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of healthcare monitoring system 10. It should be understood that the healthcare monitoring system 10 shown in FIG. 1 is simplified for ease of illustration.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network.

In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In some embodiments, cOS 12 may be an application installed on a server located in a network remote from medical systems 14 and business systems 26. In other embodiments, cOS 12 may be installed on a server located in the same local area network as medical systems 14 and/or business systems 26. In some embodiments, cOS 12 may be installed on a single computer or server; in other embodiments, cOS 12 may be a distributed application residing on a plurality of devices, including virtual machines. Various implementations are possible for cOS 12, all of which are encompassed within the broad scope of the embodiments.

Medical systems 14 and business systems 26 may present various disparate systems to cOS 12, including EMRs, hospital information systems (HIS), lab and pathology systems (LIS), imaging systems (PACS, RIS), pharmacy systems, scheduling systems, medical devices, etc. In some embodiments, each medical data source in medical system 14 may be a separate system, with its own computer network, data format and proprietary applications. In other embodiments, substantially all medical data sources in medical system 14 may be part of a single system (e.g., enterprise network, software, etc.) that can interface with each other and with business systems 26. In some embodiments, each non-medical data source in business systems 26 may be a separate system, with its own proprietary data format and applications. In other embodiments, substantially all non-medical data sources in business systems 26 may be part of a single system that can interface with each other and with medical systems 14.

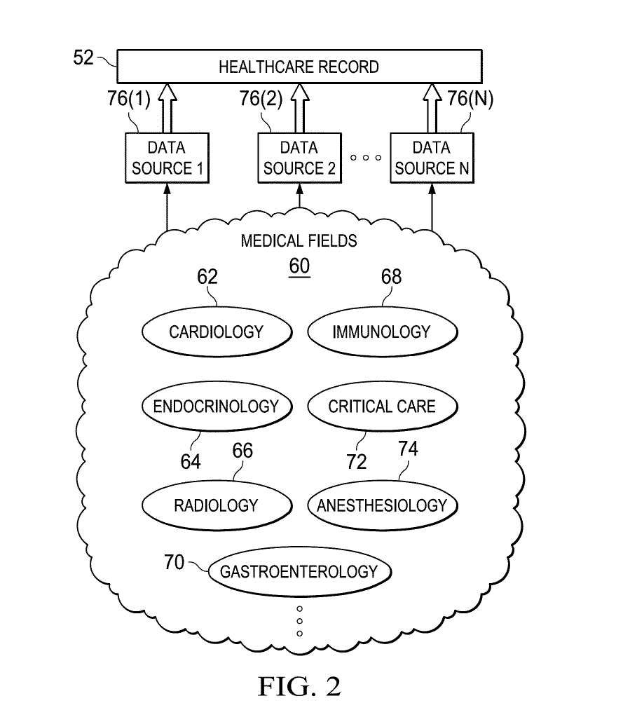

Turning to FIG. 2, FIG. 2 is a simplified block diagram illustrating example details of health record 52 according to an embodiment of healthcare monitoring system 10. Health record 52 may receive data from medical fields 60. Medical fields 60 can include various fields, such as cardiology 62, endocrinology 64, radiology 66, immunology 68, gastroenterology 70, critical care 72, anesthesiology 74, etc. The data may be provided to health record 52 through plurality of data sources 76(1)-76(N) (e.g., data source 1, data source 2 . . . data source N). In some embodiments, each data source 76(1)-76(N) may present data in different, incompatible formats. For example, critical care 72 may present text data through data source 76(N) in a proprietary hospital format; radiology 66 may present image data through data source 76(2) in a jpeg image file, and so on. Health record 52 may present an aggregated view of the disparate data, in uniform format, that is accessible and renderable (e.g., displayed on screen, printed out, etc.) by plurality of clients 58(1)-58(N).

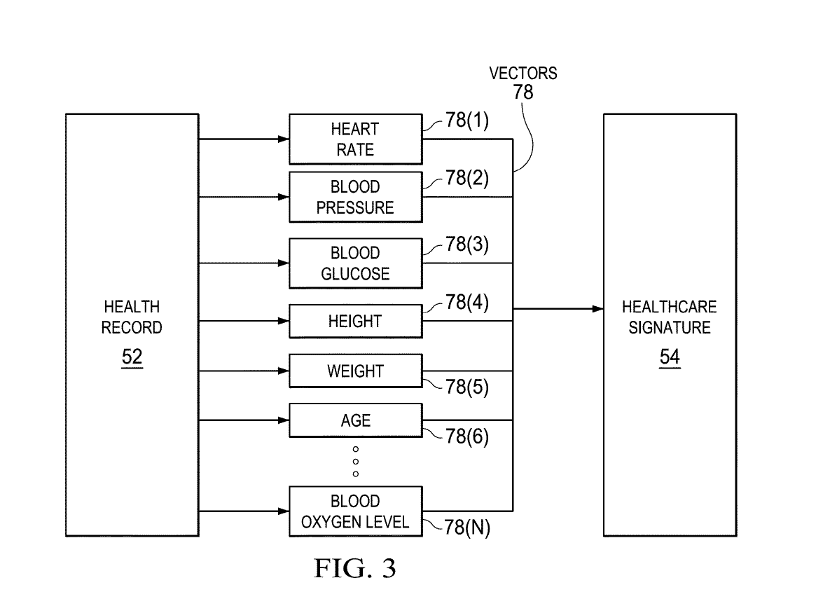

Turning to FIG. 3, FIG. 3 is a simplified block diagram illustrating example details of healthcare signature 54 according to an embodiment of healthcare monitoring system 10. Health record 52 may include data from various medical fields 60. The data may include vectors 78, such as heart rate 78(1) blood pressure 78(2), blood glucose 78(3), height 78(4), weight 78(5), age 78(6), . . . blood oxygen level 78(N). Any measurable health or medically related parameter may be included in vectors 78. Healthcare signature 54 may comprise an aggregate of vector 78. Healthcare signature 54 may be represented mathematically as an array H=[aᵢ], where H is healthcare signature 54, and aᵢ is vector 78(i).

In some embodiments, substantially all individuals whose data is stored in cOS data store 50 may be associated with different health care signature 54 comprising a common set of vectors 78. In other embodiments, each individual whose data is stored in cOS data store 50 may be associated with different health care signature 54 comprising distinct sets of vector 78. For example, individual A may be associated with health care signature 54 including blood pressure, heart rate, brain activity, oxygen level in the blood, cholesterol level, body temperature, hair growth rate and kidney activity; individual B may be associated with health care signature 54 including height, weight, age, blood pressure, heart rate, pulse, eye sight, nerves, and performance of the liver, lungs and kidneys.

According to an embodiment of healthcare monitoring system 10, vital sign monitoring sensors and other types of sensors of medical systems 14 may transmit medical data to cOS 12. For example, a person could have a monitor for heart attacks that would automatically call 911 in case of heart trouble. Another example includes health monitors that send healthcare signature 54 to a doctor's office while an individual sets up a call with the nurse. The nurse can review healthcare signature 54 to determine if the individual's medical needs can be met by the nurse's care, or if the individual would have to see the doctor.

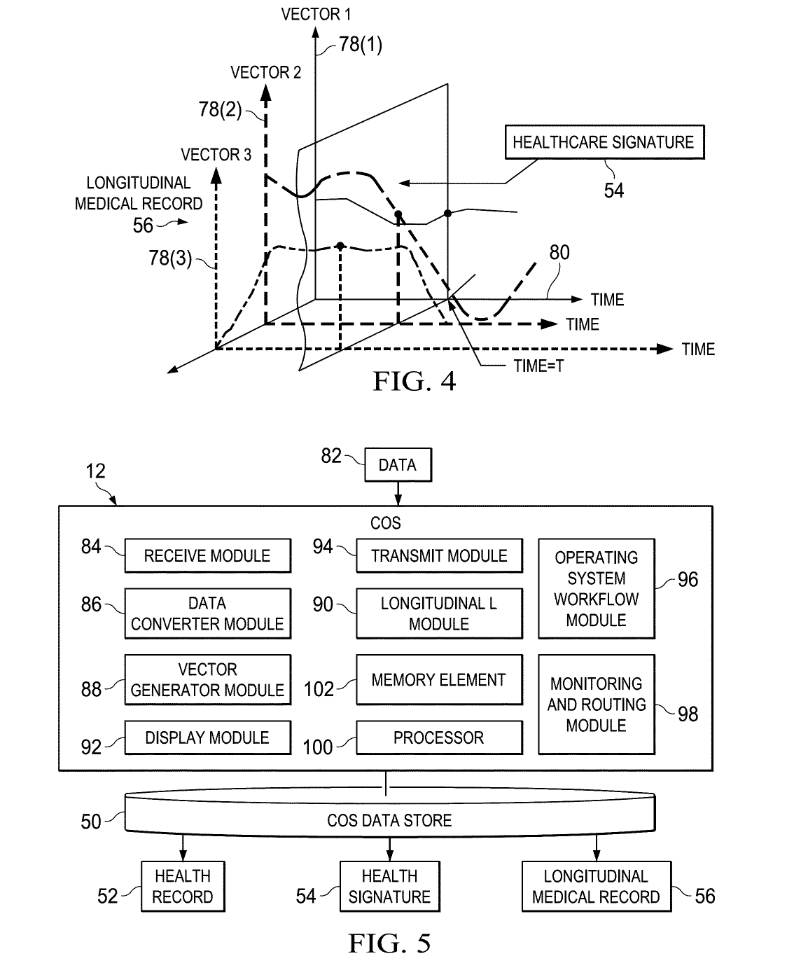

Turning to FIG. 4, FIG. 4 is a simplified block diagram illustrating example details of longitudinal medical record 56 according to an embodiment of healthcare monitoring system 10. Longitudinal medical record 56 may be represented as N curves, each curve i representing vector 78(i) plotted over time 90. A snapshot of vectors 78(1)-78(N) at an instant of time (time=T) represents healthcare signature 54 at time T. Longitudinal medical record 56 of an individual may be used to assess a health history of the individual.

Turning to FIG. 5, FIG. 5 is a simplified block diagram illustrating example details of healthcare monitoring system 10. A receive module 84 in cOS 12 may receive data 82 (including medical data and non-medical data). A data converter module 86 may convert data 82 into a uniform format (e.g., associated with health record 52). A vector generator module 88 may extract vectors 78 from data 82, and generate healthcare signature 54. A longitudinal module 90 may track vectors 78 over time, generate longitudinal medical record 56. In some embodiments, data converter module 86 may store health record 52 in cOS data store 50; vector generator module 88 may store healthcare signature 54 in cOS data store 50; and longitudinal module 90 may store longitudinal medical record 56 in cOS data store 50.

A display module 92 may facilitate displaying health record 52, healthcare signature 54, longitudinal medical record 56 and other information in suitable formats on an appropriate interface (e.g., on a display screen at client 58(1)). A transmit module 94 may facilitate transmitting data 82 to authorized users. An operating system workflow module 96 may keep track of processes in cOS 12. A monitoring and routing module 98 may monitor communication within cOS 12 and with external entities, including medical systems 14, business systems 26 and clients 58. A processor 100 and a memory element 102 may facilitate performing various operations described herein.

In various embodiments, operating system workflow module 96 may orchestrate workflows by utilizing built-in activity types, support process analysis by tracking performance and cost measures of activities in a given workflow context, and provide event driven instance control, among other features. For example, a specific workflow may include receiving data 82 at receiver 84, converting data 82 into a uniform format at data converter module 86, and storing the uniformly formatted in cOS data store 50. Operating system workflow module 96 may track processes at each module, and provide event driven control, for example, triggering specific modules as and when they are called.

In an example embodiment, data 82 may include messages to a particular physician at a hospital. The messages may include facsimiles, emails, and scanned paper mails. Monitoring and routing module 98 may identify clients 58 (e.g., 58(1)) associated with the particular physician, to which to send the messages. Data converter module 86 may convert data 82 to a uniform format. Transmit module 94 may send the messages to specific client 58(1) associated with the particular physician. Display module 92 may facilitate displaying the messages on a suitable interface. For example, display module 92 may package the uniformly formatted messages in an appropriate XML document, which can be suitably rendered by the client's web browser.

In another example embodiment, data 82 may include medical data from various medical devices 24 in disparate, incompatible formats. The medical data may be associated with a particular individual, for example, identified by a unique identifier (e.g., social security number). Monitoring and routing module 98 may identify health record 52 associated with the particular individual from the unique identifier. Data converter module 86 may convert data 82 to a uniform format and store the uniformly formatted data into health record 52 associated with the particular individual having the unique identifier. A physician may later access health record 52 on clients 58 by querying the unique identifier. Display module 92 may facilitate displaying the messages on a suitable interface on client 58.

In some embodiments, the various modules (e.g., receive module 84, data converter module 86, vector generator module 88, longitudinal module 90, display module 92, transmit module 94, operating system workflow module 96, monitoring and routing module 98) illustrated in the FIGURE may form a portion of an application in cOS 12. In other embodiments, each module may be a separate application running in cOS 12. In yet other embodiments, each module may include various hardware and software elements configured to perform the corresponding operations. In yet other embodiments, some of the modules may be implemented in hardware, and the other modules may be implemented in software.

For example, receive module 84 may include suitable network interfaces for interfacing with other network elements in network 11. Receive module 84 may include signal processors, and other hardware to enable it to perform its operations. In another example, data converter module 86 may be implemented in software and may include file format identifiers, file content based format identifiers, MIME type identifiers, etc. Data converter module 86 may also include data converters that can convert data from one format into another (e.g., uniform format). Incoming data whose format cannot be identified may be converted into a default format (e.g., image format) that can be rendered suitably on an appropriate interface.

In yet another example, vector generator module 88 may include parsers and other syntactic analyzers that can identify vectors 78 and extract them as needed. Vector generator module 88 may parse health record 52 (or data 82), identify vectors 78, extract them into temporary files, aggregate the extracted vectors 78 and insert them into health signature 54. Vector generator module 88 may include hardware and software that can enable the above described functionalities, among others.

In yet another example, longitudinal module 90 may include scripts that can review timestamps of data, and/or retrieve relevant vectors 78 from cOS data store 50 based on timestamps of the original data 82. Longitudinal module 90 may temporarily store retrieved vectors 78 and aggregate them over time to generate longitudinal medical record 56. Appropriate hardware and software components to enable such operations may be included in longitudinal module 90.

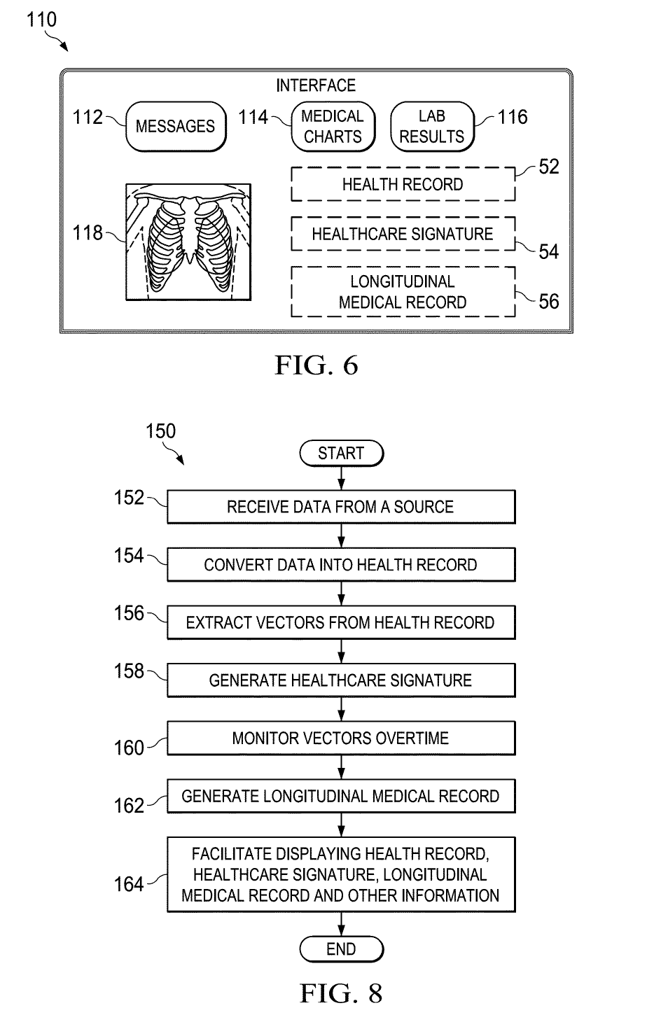

Turning to FIG. 6, FIG. 6 is a simplified diagram illustrating example details of an interface 110 for displaying data on clients 58(1)-58(N). Interface 110 may include messages 112, medical charts 114, lab results 116, medical images 118, health record 52, healthcare signature 54, and longitudinal medical record 56. Data pertaining to the various modules may be presented in separate locations on interface 110. In an example embodiment, data presented on interface 110 may be in a uniform format, rendered locally at client 58, for example, with the client's web browser. In some embodiments, data presented on interface 110 may be specific to a particular patient. In other embodiments, data presented on interface 110 may be a combination of data specific to a particular patient, and general data (e.g., messages 112 may include information unrelated to the particular patient). In yet other embodiments, data presented on interface 110 may be specific to the viewer (e.g., physician), for example, presenting data on substantially all patients who are scheduled for the day.

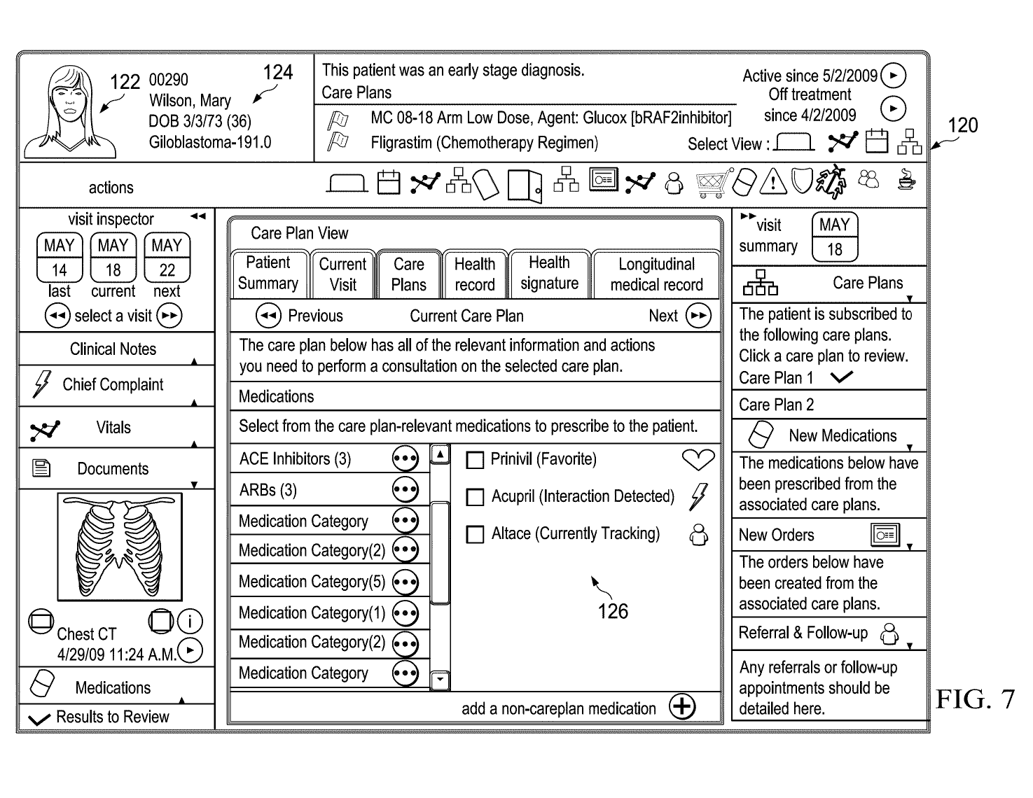

Turning to FIG. 7, FIG. 7 is a simplified diagram illustrating an example interface 120 according to an embodiment of healthcare monitoring system 10. Interface 120 may include an image 122 of the individual whose data is displayed thereon. Identifying information (e.g., name, date of birth, etc.) 124 may also be displayed. Medical and non-medical data may be suitably displayed on interface 120 according to particular needs. For example, patient summary, current visit, care plans, health record, healthcare signature, longitudinal medical records, etc. may be displayed on a portion 126 of interface 120. In the embodiment shown in the FIGURE, choices of data may be presented as clickable tabs. By clicking on the respective tab, the corresponding data may be displayed. For example, the FIGURE shows care plans selected, and corresponding data displayed on interface 120. Various other information, such as chief complaints, clinical notes, vitals, chest CT scan, care plans, medications, referrals, etc. may be displayed also in suitable portions of interface 120.

Virtually any relevant data may be displayed on interface 120, based on particular needs and user roles. For example, a billing administrator may see a different display compared to a physician. The billing administrator may see data relevant to billing, for example, payment history, current payment due, etc., and the medical information may not be visible, due to security and privacy concerns, among other reasons. Although the data presented on interface 120 may be pulled from the same source (e.g., cOS data store 50), and even from the same dataset (e.g., health record 52), embodiments of healthcare monitoring system 10 may enable displaying a portion of the data on interface 120 based on the user roles and preconfigured preferences. Thus, for example, the physician and billing administrator viewing health record 52 of the same patient simultaneously may see completely different portions of health record 52.

Turning to FIG. 8, FIG. 8 is a simplified flow diagram illustrating example operations that may be associated with embodiments of healthcare monitoring system 10. Operations 150 may include 152, at which data 82 may be received from a suitable data source (e.g., data source 76) in medical system 14 or billing system 26. At 154, data 82 may be converted into health record 52. At 156, vectors 78 may be extracted from health record 52. At 158, healthcare signature 54 may be generated from vectors 78. At 160, vectors 78 may be monitored over time. At 162, longitudinal medical record 56 may be generated. At 164, cOS 12 may facilitate displaying health record 52, healthcare signature 54, longitudinal medical record 56 and other information (e.g., messages, patient summary, etc.) on suitable interface 110.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. As used herein, the term “application” can be inclusive of an executable file comprising instructions that can be understood and processed on a computer, and may further include library modules loaded during execution, object files, system files, hardware logic, software logic, or any other executable modules.

In example implementations, at least some portions of the activities outlined herein may be implemented in software in, for example, cOS 12. In some embodiments, one or more of these features may be implemented in hardware, provided external to these elements, or consolidated in any appropriate manner to achieve the intended functionality. The various network elements may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, cOS 12 described and shown herein (and/or its associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory element 102, cOS data store 50) can store data used for the operations described herein. This includes the memory element being able to store instructions (e.g., software, logic, code, etc.) in non-transitory media such that the instructions are executed to carry out the activities described in this Specification.

A processor can execute any type of instructions associated with the data to achieve the operations detailed herein in this Specification. In one example, processors (e.g., processor 100) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, components in healthcare monitoring system 10 can include one or more memory elements (e.g., memory element 102, cOS data store 50) for storing information to be used in achieving operations as outlined herein. These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs.

The information being tracked, sent, received, or stored in healthcare monitoring system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, healthcare monitoring system 10 may be applicable to other exchanges or routing protocols. Moreover, although healthcare monitoring system 10 has been illustrated with reference to particular elements and operations that facilitate the communication process, these elements, and operations may be replaced by any suitable architecture or process that achieves the intended functionality of healthcare monitoring system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving data from a source, wherein the data comprises medical data and non-medical data associated with an individual;
converting the data into a health record of the individual;
extracting a plurality of vectors from the medical data in the health record; and
generating a healthcare signature of the individual from the plurality of vectors.

2. The method of claim 1, wherein the medical data is generated by one or more medical systems and comprise information from one or more medical fields, and further wherein the medical data from different sources are in different formats.

3. The method of claim 2, wherein the health record comprises an aggregation of the medical data provided in a uniform format, wherein the uniform format is accessible and render-able by a plurality of different clients.

4. The method of claim 1, wherein the healthcare signature is used to assess a health condition of the individual within a specific time duration.

5. The method of claim 1, further comprising:
monitoring the plurality of vectors over time; and
generating a longitudinal medical record of the individual.

6. The method of claim 5, wherein the longitudinal medical record is used to assess a health history of the individual.

7. The method of claim 5, further comprising:
facilitating displaying the health record, the healthcare signature and the longitudinal medical record of the individual on an interface.

8. The method of claim 7, further comprising:
facilitating displaying other information, comprising non-medical data, on the interface.

9. The method of claim 8, wherein the other information includes messages, medical charts, laboratory results, and images.

10. The method of claim 8, wherein the interface is configured to facilitate communicating, displaying, reviewing, and manipulating the health record, the healthcare signature, the longitudinal medical record, and the other information.

11. Logic encoded in non-transitory media that includes instructions for execution and when executed by a processor, is operable to perform operations comprising:
receiving data from a source, wherein the data comprises medical data and non-medical data associated with an individual;
converting the data into a health record of the individual;
extracting a plurality of vectors from the medical data in the health record; and
generating a healthcare signature of the individual from the plurality of vectors.

12. The logic of claim 11, wherein the medical data is generated by one or more medical systems and comprise information from one or more medical fields, and further wherein the medical data from different sources are in different formats.

13. The logic of claim 11, further comprising:
monitoring the plurality of vectors over time; and
generating a longitudinal medical record of the individual.

14. The logic of claim 13, further comprising:
facilitating displaying the health record, the healthcare signature and the longitudinal medical record of the individual on an interface.

15. The logic of claim 14, wherein the interface is configured to facilitate communicating, displaying, reviewing, and manipulating the health record, the healthcare signature, the longitudinal medical record, and other information.

16. An apparatus, comprising:
a receive module;
a data converter module;
a vector generator module;
a memory element to store data; and
a processor to execute instructions associated with the data, wherein the receive module, the data converter module, the vector generator module, the longitudinal module, the display module, the processor and the memory element cooperate such that the apparatus is configured for:
receiving data from a source, wherein the data comprises medical data and non-medical data associated with an individual;
converting the data into a health record of the individual;
extracting a plurality of vectors from the medical data in the health record; and
generating a healthcare signature of the individual from the plurality of vectors.

17. The apparatus of claim 16, wherein the medical data is generated by one or more medical systems and comprise information from one or more medical fields, and further wherein the medical data from different sources are in different formats.

18. The apparatus of claim 16, further comprising a longitudinal module, wherein the apparatus is further configured for:
monitoring the plurality of vectors over time; and
generating a longitudinal medical record of the individual.

19. The apparatus of claim 18, further comprising a display module, wherein the apparatus is further configured for:
facilitating displaying the health record, the healthcare signature and the longitudinal medical record of the individual on an interface.

20. The apparatus of claim 19, wherein the interface is configured to facilitate communicating, displaying, reviewing, and manipulating the health record, the healthcare signature, the longitudinal medical record, and other information.
